(19) United States
(12) Patent Application Publication
(10) Pub. No.: US 2026/0369699 A1
(43) Pub. Date: Nov. 19, 2026

(54) QUASI-SOLID-STATE ELECTROLYTES, ELECTROCHEMICAL CELLS, AND RELATED METHODS

(71) Applicant: Purdue Research Foundation, West Lafayette, IN (US)

(72) Inventors: Vilas G. Pol, West Lafayette, IN (US); Annie Sun, Lafayette, IN (US)

(21) Appl. No.: 19/121,956

(22) PCT Filed: Oct. 25, 2023
(86) PCT No.: PCT/US2023/035847

§ 371 Date: Apr. 17, 2025

Related U.S. Application Data
(60) Provisional application No. 63/380,815, filed on Oct. 25, 2022.

(51) Int. Cl. H01M 10/42; H01M 4/02; H01M 4/134; H01M 4/136; H01M 4/38; H01M 4/58; H01M 10/056

(52) U.S. Cl. CPC H01M 10/4235; H01M 4/134; H01M 4/136; H01M 4/382; H01M 4/5825; H01M 10/056; H01M 2004/027; H01M 2004/028; H01M 2300/0071; H01M 2300/0082; H01M 2300/0091

(57) ABSTRACT

Quasi-solid-state electrolytes, electrochemical cells made with such electrolytes, and associated methods. The quasi-solid-state electrolyte includes a mixture of solid polymer electrolyte and a fire retardant solvent, such as triethyl phosphate (TEP), (trimethylphosphate (TMP), and/or hexamethylphosphoramide (HMPA). In some arrangements, the solid polymer electrolyte may include any one or more of polyvinylidene fluoride (PVDF), LiC₂F₆NO₄S₂ (LiTFSI), and Li_{6.40}La₃Zr_{1.40} Ta_{0.60}O₁₂ ceramic (LLZTO). An electrochemical cell includes the quasi-solid-state electrolyte claims ionically coupling a cathode with an anode. Methods of forming the quasi-solid-state electrolyte are also provided.

### BACKGROUND OF THE INVENTION

The invention generally relates to quasi-solid-state electrolytes, electrochemical cells made with such electrolytes, and associated methods therefor.

The development of advanced energy storage technologies is an important component of an electrified future. Electrochemical storage cells, such as batteries, are typically used for energy storage.

Lithium-ion batteries (LIBs) are used for many different electrochemical energy storage needs. Commercially available LIBs typically use ion intercalation reactions in which lithium ions reversibly travel between a cathode and anode through a liquid electrolyte (LE). However, liquid electrolytes are often combustible, cannot inhibit lithium dendrites, and/or possess a limited electrochemical window of oxidative and reductive stability. Subsequently, undesirable reactions often occur over the lifespan of a LE LIB until the onset of thermal runaway and have potential fire and/or toxicity hazards. In addition to safety issues, conventional LE LIBs may soon reach a point of diminishing returns in energy density improvements with current materials.

Solid-state batteries (SSB) typically have solid electrodes and a solid electrolyte rather than a liquid or polymer gel electrolyte. Solid-state batteries have some promising advantages over liquid batteries in certain applications. For example, solid-state batteries are typically less prone to ignition than their LE counterparts, suppress lithium dendrites, and show better compatibility with a lithium metal anode (LMA) that offers high energy density. However, solid-state batteries are still largely a field of technology under development and prototyping, rather than current commercial products that are competitive. Although promising in many aspects, solid-state batteries often exhibit difficulties related to solid-state ionic diffusion and solid-solid interfacial incompatibility. Challenges to widespread adoption and use of solid-state batteries include lower energy and power density, durability, material costs, sensitivity, and stability. Many of these performance and production characteristics are directly related to the electrolyte used in the battery.

Therefore, it would be desirable to have a high-performance solid electrolyte for producing a high energy-density, safe, and reliable battery that may combine positive features of both a solid-state battery and a liquid electrolyte battery.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, quasi-solid-state electrolytes suitable for use in solid-state batteries, methods for their manufacturing, and electrochemical cells equipped therewith.

According to one nonlimiting aspect of the present invention, a quasi-solid-state electrolyte includes a mixture of a solid polymer electrolyte and a fire retardant solvent. In some arrangements, the solid polymer electrolyte may include any one or more of polyvinylidene fluoride (PVDF), LiC₂F₆NO₄S₂ (LiTFSI), and Li_{6.40}La₃Zr_{1.40}Ta_{0.60}O₁₂ ceramic (LLZTO), for example, in a solid mass ratio of 10:9:1, and/or the fire retardant solvent may be greater than 20 to less than 56% by weight of the quasi-solid-state electrolyte.

According to another nonlimiting aspect, a method of manufacturing a quasi-solid-state electrolyte of the present invention includes combining PVDF and LiTFSI with a fire retardant solvent to form a homogeneous solution, adding LLZTO to the homogenous solution to form an intermediate mixture, and drying the intermediate mixture to partially dehydrofluorinate the PVDF to form a polymer matrix comprising lithium-ion percolation channels. In some arrangements, the drying step may include first allowing the intermediate mixture to dry under ambient pressure until touch-dry, and thereafter vacuum drying the touch-dry mixture to remove a controlled portion of the fire retardant solvent to form the matrix, for example, having the fire retardant in an amount of greater than 20 to less than 56% by weight of the quasi-solid-state electrolyte.

According to yet another nonlimiting aspect of the present invention, an electrochemical cell includes a cathode, an anode spaced apart from the cathode, and a quasi-solid-state electrolyte of the present disclosure ionically coupling the cathode with the anode. In some arrangements, the cathode may include LiFePO₄ (LFP) and/or the anode may be or include a lithium metal anode (LMA). The electrochemical cell may form or be part of a quasi-solid-state battery, such as a flexible solid-state battery.

In some arrangements, the quasi-solid-state electrolyte, electrochemical cell, and/or methods of the present disclosure are preferably capable of providing for a high energy-density, safe, and reliable battery or other electrochemical cell that may combine positive features of both a solid-state battery and a liquid electrolyte battery.

These and other aspects, arrangements, features, and/or technical effects will be appreciated from the following detailed description.

### BRIEF DESCRIPTION OF THE DRAWINGS

FIGS. 1A to 1E show graphical representations of data obtained from various tests on the quasi-solid-state electrolyte (QSSE; also referred to herein as a composite solid polymer electrolyte (CSPE) or a composite solid electrolyte (CSE)) according to nonlimiting aspects of the present invention with triethyl phosphate (TEP) fire retardant employed as a solvent. FIG. 1A illustrates linear sweep voltammetry (LSV) for electrochemical stability comparison of liquid and solid electrolytes, including the quasi-solid-state electrolyte with the TEP solvent. FIG. 1B plots thermogravimetric analyses (TGA) of composite solid electrolytes with different solvent systems, including the quasi-solid-state electrolyte with the TEP solvent. FIG. 1C illustrates the electrochemical performance of LFP|TEP CSE|LMA full cells having charge and discharge voltage curves from galvanostatic cycling at 0.1 C using the quasi-solid-state electrolyte with the TEP solvent. FIG. 1D illustrates the coulombic efficiency and specific capacity from galvanostatic cycling of a full cell using the quasi-solid-state electrolyte with the TEP solvent. FIG. 1E illustrates a Nyquist plot from electrochemical impedance spectroscopy (EIS) comparing CSEs (CSPEs), including one CSE having the quasi-solid-state electrolyte with the TEP solvent, in which bulk impedance is modeled with an equivalent circuit for determining ionic conductivity.

FIGS. 2A and 2B show a free-standing sheet of a quasi-solid-state electrolyte (“CSPE”) containing the TEP solvent in accordance with nonlimiting aspects the present invention. FIG. 2A shows the CSPE film, and FIG. 2B shows the highly flexible and durable properties of the CSPE film.

FIG. 2C is a graphical representation of differential scanning calorimetry (DSC) showing thermal safety of the CSE (CSPE) film.

FIG. 3 is a diagrammatic illustration of an electrochemical cell with a quasi-solid-state electrolyte in accordance with nonlimiting aspects of the present invention.

FIG. 4 is a graphical representation of data from LSV tests using stainless steel (SS)|CSE|Li cells for electrochemical stability comparison of LE and CSEs (CSPEs), including CSE having the quasi-solid-state electrolyte with the TEP solvent.

### DETAILED DESCRIPTION OF THE INVENTION

The intended purpose of the following detailed description of the invention and the phraseology and terminology employed therein is to describe what is shown in the drawings, which relate to one or more nonlimiting embodiments of the invention, and to describe certain but not all aspects of what is depicted in the drawings, including the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to recite what at least provisionally are believed to be aspects of the invention, including certain but not necessarily all of the aspects and alternatives described in the detailed description.

According to some nonlimiting aspects of the disclosure, a quasi-solid-state lithium-ion battery includes an Li_{6.40}La₃Zr_{1.40}Ta_{0.60}O₁₂ ceramic (LLZTO)-polyvinylidene fluoride (PVDF)-LiC₂F₆NO₄S₂ (LiTFSI) electrolyte of the present invention in the presence of an effective amount of a suitable fire retardant employed as a solvent, yielding what is referred to herein as a quasi-solid-state electrolyte (QSSE; also referred to herein as a composite solid polymer electrolyte (CSPE) or a composite solid electrolyte (CSE)). Notable but nonlimiting examples of suitable fire retardants include TEP (triethyl phosphate), TMP (trimethylphosphate) and HMPA (hexamethylphosphoramide). As used herein, a suitable fire retardant solvent has an intermediary dielectric constant (preferably about 10 to about 30), exhibits solubility in the polymer matrix (PVDF) as quantified by Hansen solubility parameters, and exhibits solubility for lithium salts. In investigations leading to the present invention, effective amounts of fire retardant solvent were concluded to be greater than 20% by weight up to less than 56% by weight of the CSPE, with lower contents not meeting the criterion of being a “quasi-solid-state” and higher contents being associated with poor performance and less stable voltage profiles. In the investigations reported herein, TEP was utilized as the fire retardant solvent. TEP has a high boiling point (215 °C) and a low freezing point (−56 °C), which enhances essential ionic conductivity of the battery for applications that encounter a wide temperature range during operation. The battery is preferably, though not necessarily, capable of providing more than 300 Wh kg⁻¹ and/or providing cycling over more than 1000 charge-discharge cycles at 1 C rate to 80% of the initial capacity. However, other materials and/or ratios of materials could be used.

A nonlimiting example of a method of making a quasi-solid-state electrolyte (i.e., a CSPE or CSE) of the present invention entails dissolving PVDF and LiTFSI salts in the fire retardant solvent to produce a homogeneous transparent solution. Next LLZTO is added to the solution. Thereafter, the CSPE undergoes partial dehydrofluorination of PVDF that results in a complex interaction among the PVDF, the LLZTO, and the fire retardant solvent and creates facile lithium-ion percolation channels throughout the polymer matrix. Moreover, partial dehydrofluorination also increases the dielectric constant of the polymer, increasing its lithium salt solvation ability, which is especially significant in the present quasi-solid-state electrolyte which contains a relatively lower dielectric constant solvent (such as the fire retardant solvent) as an additive. The CSPE may be dried through a two step-process involving first to slow ambient stabilization along one interface until touch-dry (where the CSPE may be contacted without marring the surface), followed by vacuum drying to remove a controlled portion of the fire retardant solvent.

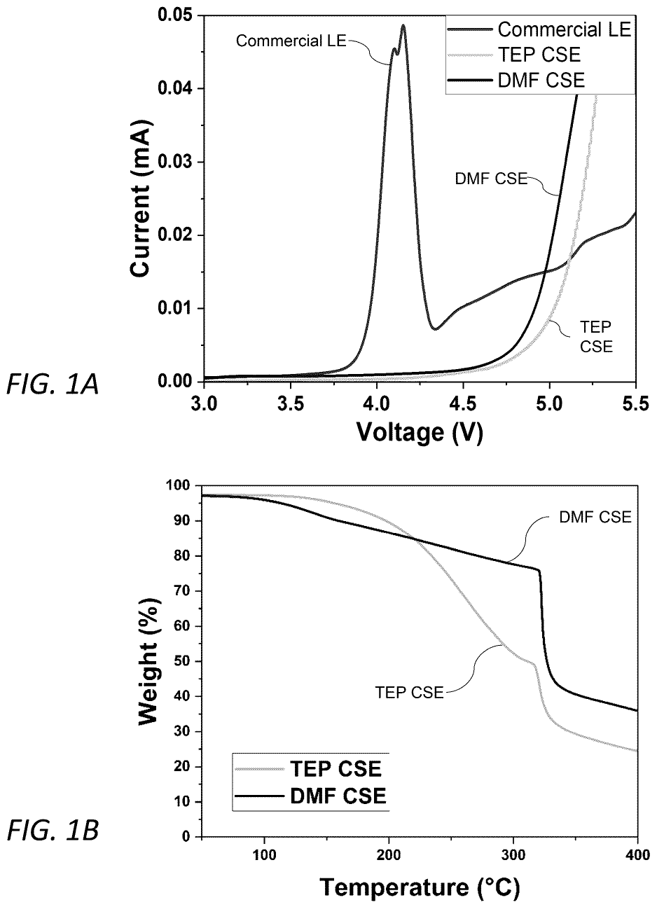

FIG. 1A demonstrates that an electrolyte in which TEP was used as the solvent was stable up to 4.8 V compared to a commercial LE that became unstable around 4 V. As seen in FIG. 1B, the TEP solvent was retained within the CSPE at a weight percent of approximately 45% (using the wt. loss % from 100-300 °C). The electrochemical performance for the LFP|TEP CSE|LMA full cells at 0.1 C rate demonstrated approximately 140 mAh/g (FIG. 1C) reversible charge and discharge capacities for the first 16 cycles (FIG. 1D) with greater than 99% coulombic efficiency. Notably, there was negligible capacity fade and very little indication of parasitic side reactions. Lithium metal full cell batteries with lithium iron phosphate (LFP) cathodes and quasi solid-state electrolyte of the present disclosure exhibit stable galvanostatic cycling. The CSPE containing the TEP solvent also exhibits high ionic conductivity up to 7×10⁻⁴ S cm⁻¹ (FIG. 1E). Because TEP has a boiling point of 215 °C and a freezing point of −56 °C, these quasi-solid-state electrolytes have the potential to serve as the backbone of broad temperature (subzero and above 50 °C) range in SSBs.

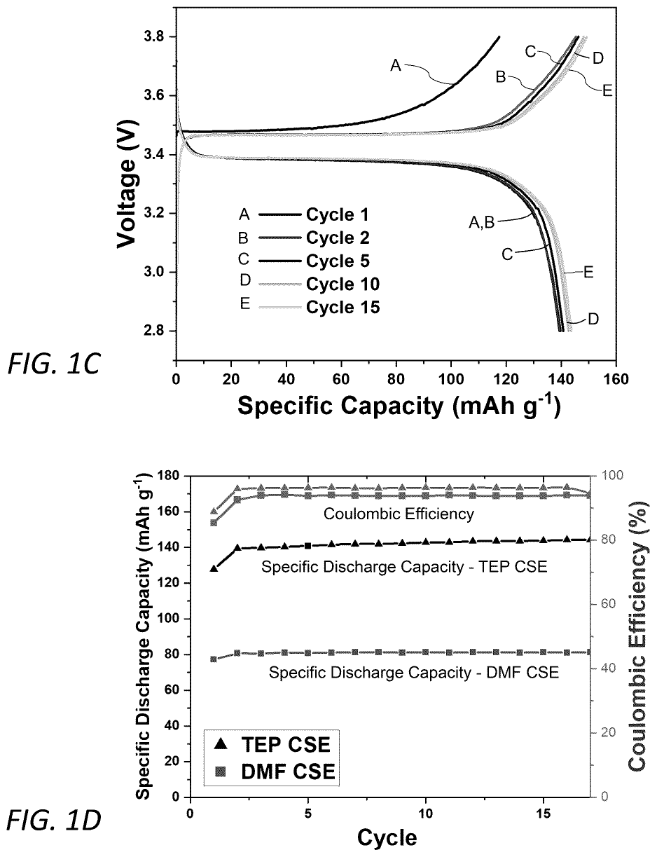

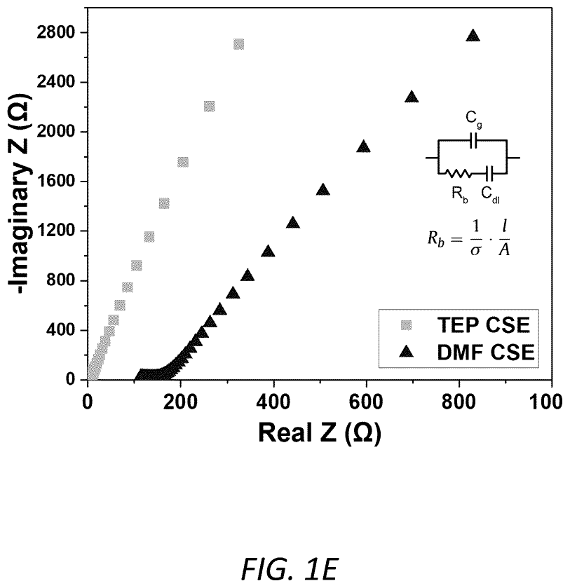

Turning to FIGS. 2A through 2C, an example sheet of a CSPE (CSE) film formed of the quasi-solid-state electrolyte 26 of the present invention is depicted. The quasi-solid-state electrolyte 26 was prepared via a low-cost, facile solution casting method to produce large size, free-standing CSPE membranes (FIG. 2A) to deform, fold, and roll (FIG. 2B). FIG. 2C shows the differential scanning calorimetry (DSC) demonstrating the heat flux exhibited by the CSPE (CSE) over a steady temperature ramp, which parallels conditions of thermal runaway steadily inducing a cycle of heat generation from degradation reactions. Notably, the conventional commercial liquid electrolyte (1.0 M LiPF₆ within EC:DEC 1:1 v/v) evidenced significant degradation reactions above 160 °C with obvious exothermic heat released as a result, while also showing heat absorption corresponding to phase transitions of the LE components. LiPF₆, though widespread in its application as a lithium salt, is prone to reaction at high temperatures with carbonate solvents. In contrast, the TEP CSE of the present disclosure exhibited very little heat released up to 300 °C and displayed small endothermic peaks around 265 °C and 290 °C, respectively. These endotherms occurred at much higher temperatures than the solvents' boiling points and may represent endothermic degradation of LiTFSI or TEP. The lack of significant endotherms was interesting in the context of FIG. 1B, which shows the significant weight percentage of the TEP solvent retained in the CSPE (45% wt. loss between 100-300 °C) compared to that of N,N-Dimethylformamide (DMF) (17% wt. loss between 100-300 °C) with similar drying procedure. Open flame tests demonstrated that the resulting CSPE had remarkable fire resistance and extreme nonflammability even in the presence of an open flame. It was theorized that the TEP residue enabled the CSPE to inherit the TEP solvent's flame retardant qualities and indicated the ability to at least partial retain some of the benefits of liquid electrolyte batteries such as interfacial compatibility and enhanced ionic conductivity, while also providing the benefits of solid-state batteries in enabling the use of the lithium metal anode, high energy density, and excellent battery safety. The specific composition of the quasi-solid-state electrolyte can be tuned to provide synergistic benefits between the fire retardant which is solvent, polymer matrix, and conductive additives that culminate in good fire resistance.

In accordance with nonlimiting aspects of the present disclosure, a battery that incorporates a quasi-solid-state electrolyte (i.e., CSPE or CSE) in place of the conventional liquid electrolyte and separator combination may allow for the eventual commercialization of a solid-state battery (SSB) system that fundamentally addresses one or more of the drawbacks with LIBs mentioned above. A quasi-solid-state electrolyte SSB in accordance with the present disclosure was concluded to be capable of combining advantages of an organic polymer electrolyte with advantages of a dispersed superionic conductor filler in order to mitigate each component's shortcomings.

The solid inorganic electrolytes (SIEs) used in investigations of the present quasi-solid-state electrolyte and subsequent battery was a Li garnet-type ceramic micron-sized powder chosen for its relatively high σ of about 10⁻³ and electrochemical stability with the lithium metal anode (LMA). It is foreseeable that other types of SIEs could be used.

The present disclosure uses PVDF as a solid polymer electrolyte (SPE), although it is foreseeable that other types of solid polymer electrolytes could be used. Different types of solid polymer electrolytes are known for use in electrochemical cells, such as organic SPEs, high molecular weight polymers, amorphous SPEs, and crystalline SPEs. In applications with LIBs, the polymer matrix preferably possesses a sufficiently high dielectric constant to solvate the lithium salt. PVDF is of interest for use as an SPE due to its partially amorphous nature, low T_{g} of −41 °C, high electrochemical and thermal stability, mechanical strength, ease of processing, and high dielectric constant.

Quasi-solid-state electrolytes represent a strategy of compromising between optimizing bulk electrolyte σ (via SIE particle dispersion) and the mechanical strength and electrochemical stability at the electrode-electrolyte interfaces (via SPE matrix). A practical quasi-solid-state electrolyte preferably demonstrates σ of greater than 10⁻⁴ S cm⁻¹, Li dendrites inhibition, electrochemical stability over a wide voltage window, and low-cost processability of polymer membranes into flexible thin films. Due to certain conductivity limitations, interfacial improvement strategies and bulk electrolyte σ improvement strategies are often implemented. However, the mitigation of interfacial and bulk conductivity issues often forces these systems to compromise on scalability (added complexity and cost) and on safety. In particular, flammable wetting agents can represent an inherent contradiction for the claimed safety benefits of SSBs for large-scale applications. Because of this LE-like remnant, a distinction is made herein between the “quasi-solid-state” (QSS) of the present disclosure from conventional “all-solid-state” or gel-type electrolytes. This QSS approach is an important feature of the electrolytes with fire retardant solvents of the present disclosure.

As previously noted, TEP was used as the fire retardant solvent of the quasi-solid-state electrolyte and battery, although other fire retardant solvents that exhibit similar characteristics as detailed herein could be used, notably such as TMP and HMPA. For the investigations, TEP was chosen as the solvent because it readily solvates PVDF and lithium salts, has a high boiling and flash point, is not highly toxic or bioaccumulative, and functions as a flame retardant via catalytic removal of free radicals released during thermal runaway. TEP has also demonstrated value, for example, as a “green solvent” for producing high-quality PVDF membranes for water filtration and as a flame-retardant additive to liquid and gel electrolytes for LIBs, but has not yet been applied for a free-standing quasi-solid-state electrolyte. In comparison with other PVDF solvents, including N-methyl-2-pyrrolidone (NMP), N,N-Dimethylacetamide (DMAc), and N,N-Dimethylformamide (DMF); TEP exhibits similar Hansen solubility parameters for solubilizing PVDF, high boiling and flash points which assist potential thermal safety, a low melting point for potential low temperature applications, and lower dielectric constant (ε) within this group of polar aprotic solvents. A comparison of characteristics of these solvents is provided in Table 1, below.

TABLE 1

| | Hansen Solubility Parameters | | | | | | | |
|---|---|---|---|---|---|---|---|---|
| | | | Hydrogen | Total | Physical Properties | | | |
| | Dispersion | Polar | Bonding | Solubility | Boiling | Flash | Melting | Dielectric |
| PVDF | δ_{d, P} | δ_{p, P} | δ_{h, P} | δh, P | Point | Point | Point | Constant |
| Solent | (MPa^{1/2}) | (MPa^{1/2}) | (MPa^{1/2}) | (MPa^{1/2}) | (°C) | (°C) | (°C) | ε |
| NMP | 18.0 | 12.3 | 7.2 | 22.9 | 202 | 96 | −24 | 32.3 |
| DMAc | 16.8 | 11.5 | 10.2 | 22.7 | 165 | 70 | −20 | 37.8 |
| DMF | 17.4 | 13.7 | 11.3 | 24.8 | 153 | 58 | −60 | 36.7 |
| TEP | 16.8 | 11.5 | 9.2 | 22.3 | 215 | 116 | −56 | 13.2 |

Without wishing to be bound by theory, it is believed that using the TEP solvent in the quasi-solid-state electrolyte lowered desolvation energy during the charge transfer of Li⁺ into the electrodes while still sufficiently solvating ion aggregation clusters. Improving interfacial charge transfer is important for preventing polarization at high current densities and causing imbalances in rates of Li deposition and solvation. By using a fire retardant such as TEP as a solvent, it was concluded that partial retention of LE battery benefits, such as interfacial compatibility and enhanced σ, may be achieved while also providing quasi-solid-state electrolyte SSB features such as the ability to use an LMA, high energy density, economical film processing, and improved safety.

The following description describes certain experimental procedures and tests that were conducted in the course of developing the quasi-solid-state electrolyte and batteries of the present disclosure.

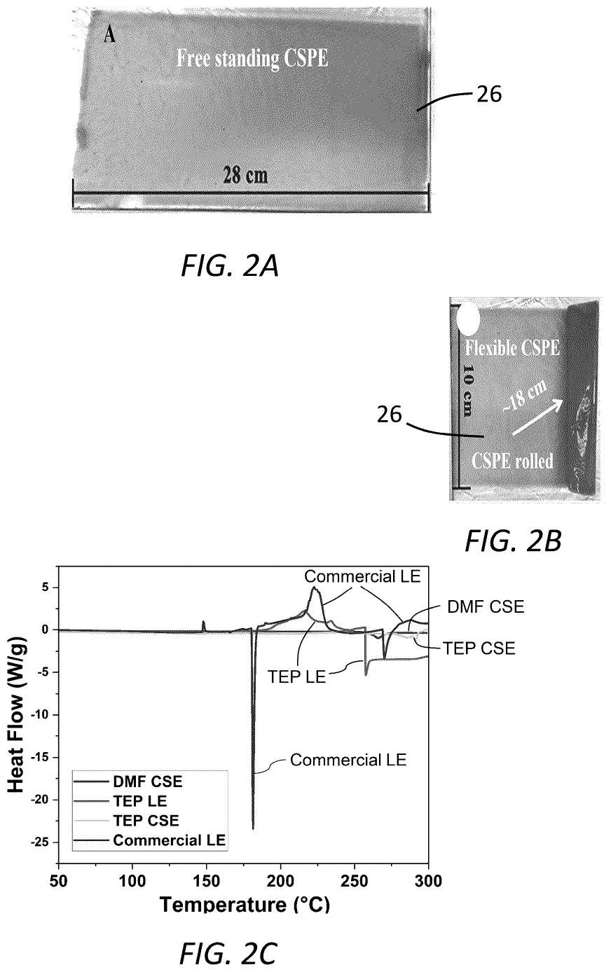

FIG. 3 schematically represents an electrochemical cell 20 that was prepared to comprise a cathode 22, an anode 24, and the quasi-solid-state electrolyte 26 ionically coupling the cathode 22 with the anode 24. The cathode 22 was prepared by blending LiFePO₄ (LFP, MSE), carbon black (Timcal, Super P), poly(vinylidene fluoride) (PVDF, Kynar HSV-900) in an 8:1:1 weight ratio into N-Methyl-2-Pyrrolidone (NMP, Sigma Aldritch) solvent via planetary centrifuge (Thinky, 800 rpm rotation, 2000 rpm revolution) for thirty minutes to form a homogenous slurry. This viscous solution was cast onto carbon-coated Al foil via doctor blade and dried at 80 °C for 24 hours. The dry cathode sheet was then punched into 16 mm diameter discs for use in CR2032 stainless-steel coin cells. To prepare the anode 24, a lithium metal anode (LMA) was prepared within an argon-filled glovebox maintained below 1.0 ppm H₂O and O₂ via a lithium metal rod (Sigma Aldritch) that was cut into 14 mm diameter discs. Within the Ar glovebox, the quasi-solid-state electrolyte (i.e., CSPE or CSE) was prepared by magnetic stirring of a 10% wt. PVDF in TEP solvent (Sigma-Aldritch) solution at 60 °C for two hours, followed by dissolution of lithium bis(trifluoromethanesulfonyl)imide (LiTFSI, TCI) salt with continued heating and stirring. Finally, Li_{6.40}La₃Zr_{1.40}Ta_{0.60}O₁₂ (LLZTO, MTI) ceramic particles were added to the container and sealed to retain the protective Ar. The PVDF:LiTFSI:LLZTO solid mass ratio was 10:9:1. After mixing in a planetary centrifuge for 1 minute, a well-dispersed viscous solution was cast on glass via doctor blade and dried under vacuum at 60 °C.

For purposes of the testing, reference commercial liquid electrolyte was used that contains 1.0 M LiPF₆ within ethylene carbonate (EC) and diethyl carbonate (DEC) (Sigma-Aldrich, 1:1 v/v, battery grade).

The electrolyte characterization and electrochemical performance of the quasi-solid-state electrolyte 26 were evaluated. To determine ionic conductivity of the quasi-solid-state electrolyte, stainless steel (SS)/CSE/SS CR2032 cells were assembled. The electrochemical impedance spectroscopy (EIS) uses a Gamry Reference 600 potentiostat in the frequency range from 106 Hz to 0.1 Hz with a perturbation of 10 mV. The ionic conductivity (σ) was calculated via the relationship σ=L/(R_{b}·S), where R_{b} is the bulk electrolyte resistance modeled by equivalent circuit from EIS measurements, L is the quasi-solid-state electrolyte thickness, and S is the area of blocking electrode contact. The potentiostat also was used for linear sweep voltammetry (LSV) on SS/CSE/Li test cells using a scan rate of 1 mV s⁻¹ over a potential range of 2.6-6 V. Thermal characterization of the electrolyte was conducted via differential scanning calorimetry (DSC, TA Q100) at a ramp rate of 10 °C min⁻¹ from 25 °C to 300 °C under Ar flow. The quasi-solid-state electrolyte was also evaluated via thermogravimetric analysis (TGA, Instrument Specialist i1000) at a ramp rate of 20 °C min⁻¹ from 30 °C to 400 °C under Ar flow. Within an Ar-filled glovebox, full cells were assembled with CR2032 casing, freshly prepared LMA, LFP cathodes, and quasi-solid-state electrolyte. The galvanostatic charge/discharge cycling for the full cells waws performed on an Arbin BT-2000 battery testing system with a voltage range of 2.8-3.8 V (vs. Li/Li⁺) at current density of 0.1 C (1 C=170 mA g⁻¹).

Solvent residue and heat flux were investigated through the DSC and TGA to confirm the presence of the retained TEP solvent in a thermally stable quasi-solid-state electrolyte. The commercial liquid electrolyte exhibited significant degradation reactions above 160 °C with obvious exothermic heat released as a result, while also showing heat absorption corresponding to phase transitions of the liquid electrolyte components. LiPF₆, though widespread in its application as a lithium salt, is prone to reaction at high temperatures with carbonate solvents. 1.0M LiTFSI in the TEP solvent as a liquid electrolyte exhibited a higher degradation temperature of 190 °C, but still exhibited appreciable exothermic degradation and endotherms likely attributable to vaporization and salt degradation after 250 °C. In contrast, the DMF quasi-solid-state electrolyte and TEP quasi-solid-state electrolyte exhibited few exothermic peaks up to 300 °C and displayed small endothermic peaks at 265 °C and 291 °C, respectively. Interestingly, these endotherms occurred at much higher temperatures than the solvents' boiling points and may represent endothermic degradation of LiTFSI. The lack of significant endotherms was interesting in the tests that showed the significant weight percentage of the TEP solvent retained in the quasi-solid-state electrolyte (45% wt. after loss between 100-300 °C) compared to that of DMF (17% wt. after loss between 100-300 °C) with similar drying procedures. The DSC results indicated the thermal stability of the quasi-solid-state electrolyte, especially because the reduction of heat released in battery systems becomes more important in large, high energy density battery configurations during thermal runaway. The TEP content was an intentional addition exceeding 20% by weight of the quasi-solid-state electrolyte, which has been previously reported as unintentionally left within electrolyte systems because the presence of a lithium salt within a polymer matrix tightly binds polar solvents (such as TEP) such that conventional drying techniques cannot easily remove the TEP solvent, such that 10-20% wt. of the solvent may remain. Notably, additional testing at higher TEP solvent contents indicated instability at levels of 56% be weight of TEP in the quasi-solid-state electrolyte. Such contents were concluded to be applicable to other suitable fire retardant solvents, such as TMP and HMPA.

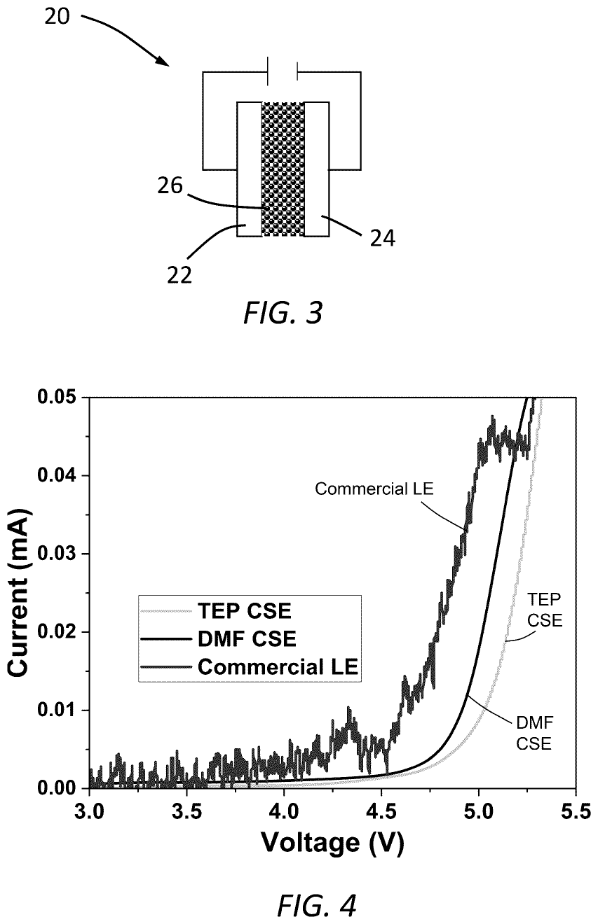

The electrochemical stability of the quasi-solid-state electrolyte's oxidative stability was tested at high potentials through LSV. In FIG. 4, the LSV demonstrated the voltage at which electrochemical degradation begins. The quasi-solid-state electrolytes with the TEP solvent or DMF evidenced a wider electrochemical voltage window up to 4.6 V, whereas the commercial LE showed a degradation peak beginning at 4.2 V. In particular, the TEP quasi-solid-state electrolyte 26 demonstrated similar electrochemical stability at its Li-contacting interface to that of the low solvent residue DMF quasi-solid-state electrolyte, despite the inherent electrochemical instability of the TEP solvent in purely liquid systems. The thermal and electrochemical stability demonstrated by the highly TEP-plasticized quasi-solid-state electrolyte 26 evidenced the compatibility of the system for safe battery operations. The TEP quasi-solid-state electrolyte 26 was able to match or exceed the stability of its DMF counterpart despite its composition containing a large proportion of solvent residue.

Direct electrochemical tests showed the advantages in electrochemical performance of this quasi-solid-state electrolyte design (the quasi-solid-state electrolyte 26) with respect to bulk ionic conductivity and lowered interfacial impedance. As seen in FIG. 1C, the LFP/TEP CSE/LMA full cell displayed reversible discharge capacity of over 140 mAh g⁻¹, with excellent capacity retention over initial cycling. The cells with the quasi-solid-state electrolyte 26 did not exhibit the capacity fade seen in many conventional solid-state cells as a result of interfacial pulverization and the formation of piecemeal contact points during electrode expansion and contraction throughout cycling, potentially due to the electrolyte composition contributing to forming a stable SEI layer. The TEP quasi-solid-state electrolyte full cell of the present invention also displayed Coulombic efficiency (CE) of 96% that remains steady over cycling. The first cycle possessed a lower CE of 88%, reflecting the initial irreversible consumption of Lit in the formation of the SEI layer. In contrast, the DMF quasi-solid-state electrolyte displayed slightly lower CE of 94%. The lower specific discharge capacity of the DMF quasi-solid-state electrolyte (81 mAh g⁻¹) indicating that the interfacial resistance created large kinetic barriers to full utilization of the LFP particles in intercalation reactions. FIG. 1E depicts the ionic conductivities of the quasi-solid-state electrolytes examined by the impedance measurements. From the AC impedance measurements, an equivalent circuit shown in FIG. 1E may be used to interpret the complex impedance readings and find bulk resistance (R_{b}) in series with double-layer capacitance (C_{dl}) of the interface and in parallel with geometric capacitance response (C_{g}). For this circuit, σ=7×10⁻⁴ S cm⁻¹ for TEP quasi-solid-state electrolyte, which is an improvement in bulk ion transport capability over the DMF quasi-solid-state electrolyte (σ=1×10⁻⁴ S cm⁻¹), due to the plasticizing effect of the residual TEP solvent to resemble LE-like ion diffusion. As such, TEP is considered compatible with the quasi-solid-state electrolyte system with respect to thermal and electrochemical stability, reduced interfacial impedance via improved cycling performance, and improved σ through EIS.

The quasi-solid-state electrolytes of the present invention are believed to address several of issues relating to conventional electrochemical storage cells. The quasi-solid-state electrolytes are reasonably flameproof, thermally stable up to over 290 °C, electrochemically stable up to 4.7V, and capable of exhibiting a high ionic conductivity of up to 7×10⁻⁴ S cm⁻¹. In lithium metal full cell batteries 20 with lithium iron phosphate cathodes 22, they exhibited stable galvanostatic cycling capabilities and excellent specific capacity up to 140 mAh g⁻¹.

Others in the field creating composite solid electrolytes have attempted to use more conventional polar aprotic organic solvents such as dimethylformamide or dimethylacetamide in their solid-state battery solution casting process. However, the inclusion of the lithium salt, conductive ceramic particles, and polymer creates a solid material that is difficult to fully dry, meaning that these organic solvents will often be left over in the solid electrolyte in appreciable quantities. The solvent residue presents an inherent contradiction for the claimed safety benefits of using solid-state battery technologies in terms of thermal and electrochemical safety.

In contrast, the approach of the present disclosure embraces this phenomenon as a key feature. Moreover, the TEP solvent possessed higher B.P. and lower M.P. (freezing point), allowing one to fabricate a quasi-solid-state lithium-ion battery that functions at both low temperatures and high temperatures. The QSS electrolyte and battery technology disclosed herein retains of some of the benefits of liquid electrolyte batteries, such as interfacial compatibility and enhanced ionic conductivity, while also providing benefits of solid-state batteries, such as enabling the use of the lithium metal anode, energy density, and better battery safety. The composition can be tuned to provide synergistic benefits between the fire retardant solvent, polymer matrix, and conductive additives.

Many potential uses for the quasi-solid-state electrolytes of the present invention are foreseeable. For example, since triethyl phosphate has a boiling point temperature of 215 °C and a freezing point of −56 °C, these quasi-solid-state electrolytes have the potential to serve as the backbone of broad temperature (subzero or above 50 °C) range lithium-ion batteries. The present invention provides a formulation for a quasi-solid-state electrolyte which contains a fire retardant that both functions to render the electrolyte effectively nonflammable, and facilitates the required ionic conductivity of lithium-ions and thus the enhanced functionality of the lithium-ion battery as a whole. The lithium salt LiTFSI and the garnet-type ceramic LLZTO in this specific composition also play an important role in battery function. The quasi-solid-state electrolyte and battery technology disclosed herein may have advantageous use in many different areas of electrical power storage and use, including for example, consumer electronics, electric vehicles, and power grid-scale energy storage utilities.

As previously noted above, though the foregoing detailed description describes certain nonlimiting aspects of one or more particular embodiments of the invention, alternatives could be adopted by one skilled in the art. For example, the electrochemical cells, quasi-solid-state electrolytes, and their components could differ in appearance and construction from the embodiments described herein and shown in the drawings, functions of certain components of the electrochemical cells, quasi-solid-state electrolytes, and their components could be performed by components of different construction but capable of a similar (though not necessarily equivalent) function, and various materials could be used in the fabrication of the electrochemical cells, quasi-solid-state electrolytes, and/or their components. As such, and again as was previously noted, it should be understood that the invention is not necessarily limited to any particular embodiment described herein or illustrated in the drawings.

1: A quasi-solid-state electrolyte for an electrochemical cell, the quasi-solid-state electrolyte comprising a mixture of solid polymer electrolyte and a fire retardant solvent.

2: The quasi-solid-state electrolyte of claim 1, wherein the fire retardant solvent is at least one chosen from the group consisting of triethyl phosphate (TEP), trimethylphosphate (TMP), and hexamethylphosphoramide (HMPA).

3: The quasi-solid-state electrolyte of claim 1, wherein the solid polymer electrolyte comprises polyvinylidene fluoride (PVDF).

4: The quasi-solid-state electrolyte of claim 1, wherein the composite solid electrolyte comprises LiC₂F₆NO₄S₂ (LiTFSI).

5: The quasi-solid-state electrolyte of claim 1, wherein the composite solid electrolyte comprises Li_{6.40}La₃Zr_{1.40}Ta_{0.60}O₁₂ ceramic (LLZTO).

6: The quasi-solid-state electrolyte of claim 1, wherein the solid polymer electrolyte consists essentially of PVDF, LiTFSI, and LLZTO in a solid mass ratio of 10:9:1 PVDF:LiTFSI:LLZTO.

7: The quasi-solid-state electrolyte of claim 1, wherein the quasi-solid-state electrolyte contains the fire retardant solvent in an amount of greater than 20% to less than 56% by weight of the quasi-solid-state electrolyte.

8: The quasi-solid-state electrolyte of claim 1, wherein the fire retardant solvent is thermally stable to at least 290 °C and electrochemically stable up to at least 4.7V.

9: The quasi-solid-state electrolyte of claim 1, wherein the fire retardant solvent has a boiling point of greater than 215 °C and a freezing point of less than −56 °C.

10: The quasi-solid-state electrolyte of claim 1, wherein the quasi-solid-state electrolyte exhibits ionic conductivity up to 7×10⁻⁴ S cm⁻¹.

11: A method of manufacturing a quasi-solid-state electrolyte, the method comprising:
combining PVDF and LiTFSI with a fire retardant solvent to form a homogeneous solution;
adding LLZTO to the homogenous solution to form an intermediate mixture; and
drying the intermediate mixture to partially dehydrofluorinate the PVDF to form a polymer matrix comprising lithium-ion percolation channels.

12: The method of claim 11, wherein the step of drying comprises:
allowing the intermediate mixture to dry under ambient pressure until touch-dry; and
vacuum drying the touch-dry mixture to remove a controlled portion of the fire retardant solvent to form the matrix.

13: The method of claim 11, wherein the step of drying forms the matrix containing the fire retardant solvent in an amount of greater than 20% to less than 56% by weight of the quasi-solid-state electrolyte.

14: The method of claim 11, wherein the fire retardant solvent is at least one chosen from the group consisting of comprises triethyl phosphate (TEP) (trimethylphosphate, TMP), and hexamethylphosphoramide (HMPA).

15: An electrochemical cell comprising:
a cathode;
an anode spaced apart from the cathode; and
the quasi-solid-state electrolyte of claim 1 ionically coupling the cathode with the anode.

16: The electrochemical cell of claim 15, wherein the cathode comprises LiFePO₄ (LFP).

17: The electrochemical cell of claim 15, wherein the anode comprises a lithium metal anode (LMA).

18: The electrochemical cell of claim 15, wherein the electrochemical cell forms a quasi-solid-state battery.

19: The electrochemical cell of claim 15, wherein the electrochemical cell comprises a flexible solid-state battery.
